(19) United States
(12) Patent Application Publication
(10) Pub. No.: US 2015/0207444 A1
(43) Pub. Date: Jul. 23, 2015

(54) MOTOR CONTROLLER WITH ENHANCED WOBBLE COMPENSATION

(71) Applicant: GM GLOBAL TECHNOLOGY OPERATIONS LLC, Detroit, MI (US)

(72) Inventors: Yo Chan Son, Rochester Hills, MI (US); Bon Ho Bae, Torrance, CA (US); Steven E. Schulz, Torrance, CA (US); Leah Dunbar, Brighton, MI (US)

(73) Assignee: GM GLOBAL TECHNOLOGY OPERATIONS LLC, Detroit, MI (US)

(21) Appl. No.: 14/159,963

(22) Filed: Jan. 21, 2014

(51) Int. Cl. H02P 6/16

(52) U.S. Cl. CPC H02P 6/16

(57) ABSTRACT

A vehicle includes a motor having a rotor shaft, a transmission having a gear set directly or selectively connected to the motor, a resolver circuit, and a controller. The resolver circuit includes a resolver that measures an absolute position of the shaft, and a resolver-to-digital converter (RDC) which receives the absolute position and generates, via a tracking loop, a raw position signal. The controller includes recorded predetermined frequency characteristics of the RDC and method instructions which cause the controller to receive the raw position signal from the RDC and create a lookup table describing position wobble. The controller compensates for the position wobble at all rotational speeds of the rotor shaft by applying the predetermined frequency characteristics to the position wobble to derive a compensated position signal. The controller also uses the compensated position signal to control an operation of the electric motor.

### TECHNICAL FIELD

The present disclosure relates to a motor controller with enhanced wobble compensation.

### BACKGROUND

A resolver is an analog rotary position sensor which measures an absolute position or angle of a rotatable shaft in an electric motor. Rotary speed may be calculated as a function of the measured shaft position, with speed and position being typical motor feedback and control values. In essence, a resolver is a rotary transformer having three windings: a primary reference winding and a pair of secondary windings, i.e., a sine (SIN) and a cosine (COS) winding connected 90 degrees apart from each other within the electric motor. The magnitude of electrical current flowing through the resolver windings varies sinusoidally with the rotation of the shaft. When the primary winding is energized, a voltage is induced in the secondary windings. The induced voltages equal the product of the reference voltage and the respective SIN and COS of the measured angle of the shaft with respect to a calibrated zero point.

In a typical motor control circuit, a Resolver-to-Digital Converter (RDC) is used to convert electrical output signals from the resolver into useful digital outputs. Two RDC outputs correspond to the measured shaft position/angle and speed. Due to certain physical anomalies, however, output signals from a given RDC may not always represent the true rotational speed of the motor shaft. Instead, a periodic variation error may repeat with each revolution of the shaft. The pattern of this variation, which is referred to in the art as position error or angular wobble, may have characteristics that contain multiple harmonics of the base revolution period of the motor shaft.

### SUMMARY

A vehicle is disclosed herein that includes an electric drive system. The electric drive system includes an electric traction motor, a resolver circuit, and a motor controller. The resolver circuit includes a resolver and a Resolver-to-Digital Converter (RDC), and may include other hardware devices such as line filters, amplifiers, demodulation chips, oscillators, tracking loop software, and the like.

Within the scope of the present invention, the controller is configured to provide enhanced error/wobble compensation for resolver-measured position and speed output signals relative to conventional wobble compensation methods. The controller may accomplish the intended result by: (1) implementing a digital filter resembling the dynamics of the RDC before compensating for wobble, which may improve the accuracy of phase and magnitude compensation for any resolver output signals containing a wobble frequency, and (2) by shifting an index of one or more lookup tables used for wobble compensation so as to simulate a phase shift by the RDC. Both approaches are described in detail below.

As is known in the art, a measured shaft position is a continuous output signal. Wobble information is selectively recorded from this output signal at a fixed interval to construct one or more lookup table(s), e.g., one for speed gain error and another for position error. For example, error or wobble information may be recorded every six degrees out of a possible 360 degree rotation of a rotor, such that the index for the lookup table ranges from a value of 0, which corresponds to 0 degrees of rotation, to 59, a value corresponding to 354 degrees of rotation. Example lookup tables for position or speed gain may contain 128 elements for one position revolution. Thus, for every 2.8125 degrees in this example, wobble information may be recorded. As a result of the presently disclosed methods, torque ripple and noise, vibration, and harshness (NVH) may be substantially reduced in an electric drive system.

In particular, a vehicle in one possible embodiment includes an electric motor, a transmission having a gear set which is directly or selectively connected to the motor, a resolver circuit having a resolver that measures a position of the rotor shaft, and a resolver-to-digital converter (RDC). The RDC receives the measured position as an input and generates, via a tracking loop of the RDC, a raw position signal as an output signal. The vehicle also includes a controller in communication with the motor and RDC. The controller may include a processor and tangible, non-transitory memory on which is recorded predetermined frequency characteristics of the resolver circuit and a set of instructions.

The instructions are selectively executable by the processor to cause the controller, which has a lookup table describing position wobble in the raw position signal, to receive the output signal from the RDC. The controller may automatically compensate the position wobble in the lookup table at all rotational speeds of the rotor shaft by applying the predetermined frequency characteristics to the position wobble to thereby derive a compensated position signal. The controller then uses the compensated position signal to control an operation of the electric motor.

The predetermined frequency characteristics may be embodied as a transfer function describing known position dynamics of the RDC. These dynamics may be applied to the position wobble to thereby derive the compensated position signal. That is, the effects of the frequency response of the RDC on wobble, which may be determined offline as a calibration value for a given RDC, may be accounted for ahead of time, i.e., predetermined at all motor speeds, and then backed out of any raw position signals. The controller may automatically compensate for the position wobble by subtracting the position dynamics from the raw position signal to derive the compensated position signal. Information in the lookup table is read by the controller as a function of the input position, i.e., by finding the corresponding data for the raw position. Depending on the method, the lookup table can either be read first with the frequency characteristics applied afterward, or the index of the lookup table can be shifted as a function of the motor speed, with the index-shifted lookup table read afterward.

The RDC may generate, via the tracking loop, a raw speed signal as another output signal. The controller derives speed dynamics from the position dynamics and calculates the compensated speed signal by subtracting the derived speed dynamics from the raw speed signal. The controller may apply an optional low-pass filter to the raw speed signal to generate a filtered raw position speed signal, and automatically shift an index of the lookup table as a function of the filtered raw position speed signal to thereby simulate a phase shift of the predetermined frequency response.

A method is also disclosed herein that includes measuring an absolute position of a rotor shaft of an electric motor via a resolver, and receiving the absolute position as an input signal via an RDC having a tracking loop. The method further includes generating from the absolute position, via the tracking loop of the RDC, a raw position signal as an output signal, and transmitting the output signal to a controller. The controller, as part of the method, references a lookup table describing position wobble in the raw position signal and automatically compensates or adjusts the position wobble in at all rotational speeds of the rotor shaft by applying predetermined frequency characteristics of the RDC to the position wobble to thereby derive a compensated position signal. An operation of the electric motor is thereafter controlled using the compensated position signal.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having an electric traction motor, a resolver circuit, and a controller that compensates for error or wobble in output signals from the resolver circuit using a method as set forth herein.

FIG. 2 is a schematic circuit diagram of an example resolver circuit useable within the vehicle of FIG. 1.

FIG. 2A is an illustration of speed and position wobble in raw output signals from the RDC shown in FIGS. 1 and 2, with the raw output signals plotted on the horizontal axes and the corresponding wobble component plotted on the vertical axes.

FIG. 2B is an illustration of an example frequency response of a tracking loop of the RDC shown in FIG. 2.

FIG. 3 is a logic flow diagram describing an example method for compensating for wobble in a motor drive system, e.g., aboard the vehicle shown in FIG. 1.

FIG. 3A is a schematic illustration describing mapping of position and speed wobble.

FIG. 4 is a logic flow diagram describing another example method for compensating for wobble in a motor drive system, e.g., aboard the vehicle shown in FIG. 1.

### DETAILED DESCRIPTION

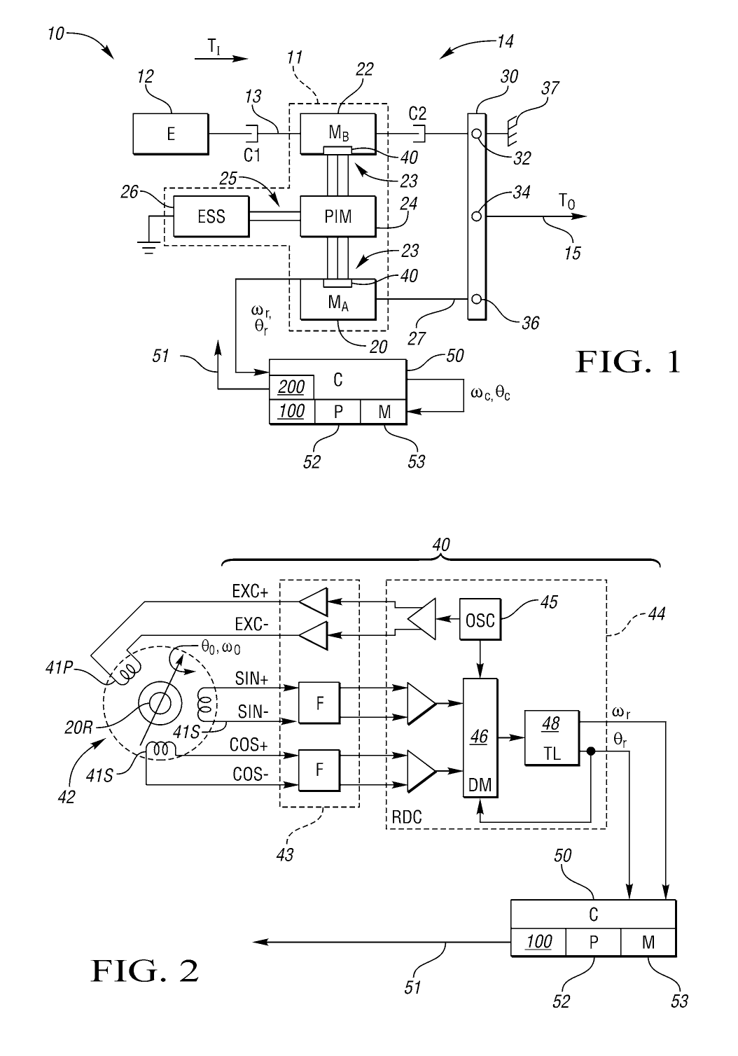

Referring to the drawings, wherein like reference numbers correspond to like or similar components throughout the several figures, an example vehicle 10 is shown schematically in FIG. 1. The vehicle 10 includes a controller (C) 50 and a motor drive system 11 having electric traction motors 20 and 22, i.e., motors M_{A} and M_{B}, respectively. The motor drive system 11 may also include a power inverter module (PIM) 24 and a rechargeable energy storage system (ESS) 26 such as a multi-cell lithium ion or nickel metal hydride battery. The traction motors 20, 22 may be supplied via an AC voltage bus 23 while DC power from the ESS 26 is provided to the PIM 24 via a separate DC voltage bus 25.

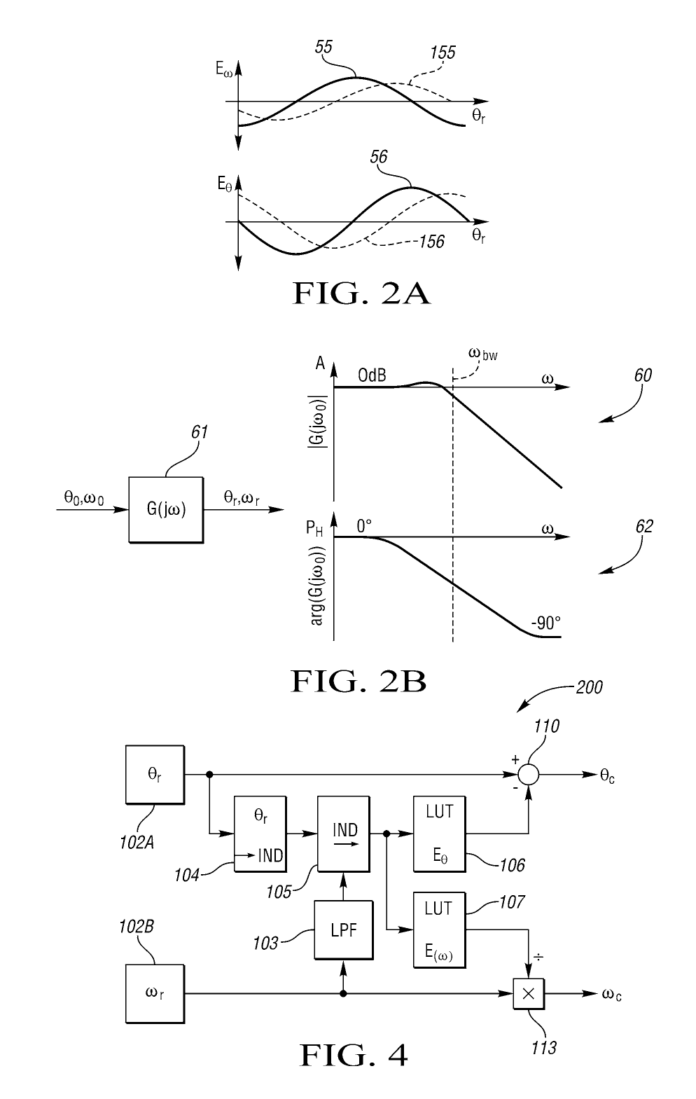

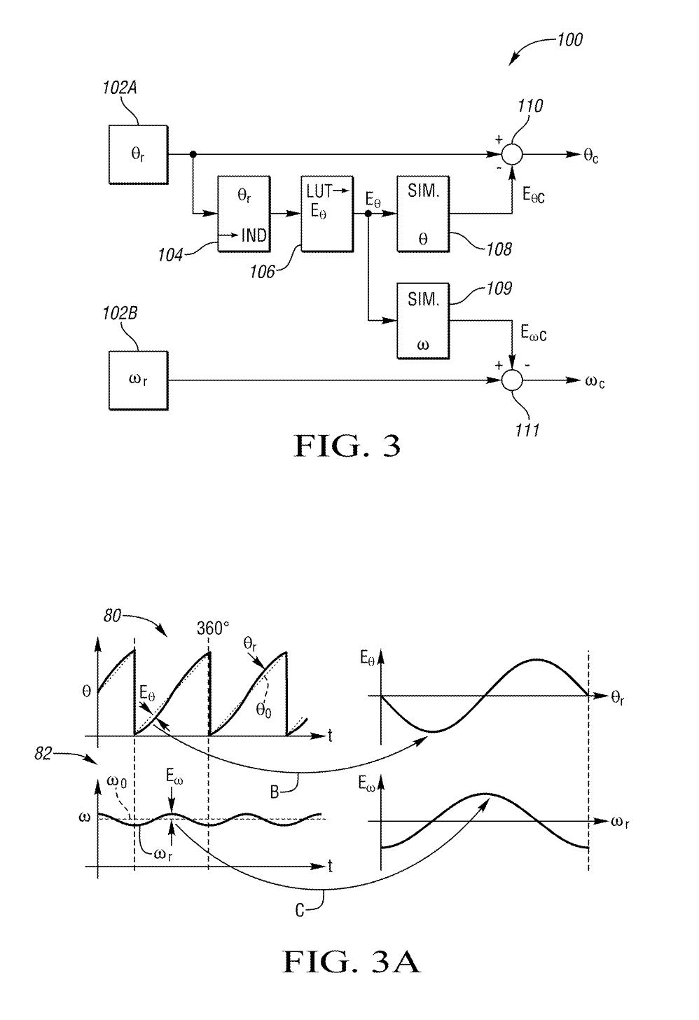

Each of the traction motors 20, 22 includes a resolver circuit 40, an example of which is shown in FIG. 2, which outputs raw position and speed signals (ωᵣ, θᵣ) to the controller 50. As part of the present control approach, the controller 50 automatically compensates for angular wobble in the position and speed signals at any motor rotation speed, as explained in further detail below with reference to FIGS. 3 and 3A, doing so via execution of method 100 of FIG. 3 or method 200 of FIG. 4. The controller 50 ultimately derives compensated position and speed signals (ω_{C}, θ_{C}) in the execution of method 100 or 200. The controller 50 can thereafter control an action of the traction motor 20 and/or 22 via control signals (arrow 51) using the compensated position and speed signals (ω_{C}, θ_{C}).

The vehicle 10 of FIG. 1 is shown in a non-limiting example embodiment of a hybrid vehicle having an engine (E) 12, the traction motors 20 and 22, and at least one gear set 30 having a set of nodes/gear elements 32, 34, and 36, e.g., a respective ring gear, sun gear, and carrier member. More or fewer traction motors, and/or more gear sets, may be used in other embodiments. The methods 100 and 200 described herein may be applied to any motor drive system 11, whether vehicular as shown in FIG. 1 or non-vehicular. However, for illustrative consistency the vehicle 10 of FIG. 1 using the motor drive system 11 in the form of an electrical propulsion system will be described hereinafter.

The vehicle 10 of FIG. 1 further includes a transmission 14 having an input member 13 and an output member 15. The transmission 14 receives input torque (T_{I}) from the engine 12 via the input member 13 and delivers output torque (T_{O}) to a set of drive wheels (not shown) via the output member 15. First and second friction clutches C1 and C2, respectively, may be actuated and released as needed via commands from the controller 50 or another control device of the vehicle 10 to establish a desired gear ratio, and to selectively change the mode of operation of the electric traction motors 20, 22.

In the example transmission 14 of FIG. 1, which is just one of many possible powertrain configurations, the electric traction motor 20 is continuously connected to node 36 of the gear set 30 via an interconnecting member 27. The output member 15 is continuously connected to the node 34, and node 32 is connected to a stationary member 37. The same node 32 is selectively connected to the electric traction motor 22 via clutch C2, while clutch C1 selectively connects the engine 12 to the input member 13. Other powertrain configurations may include only one electric traction motor, or more than the two electric traction motors 20 and 22 that are shown, with two or more gear sets and additional clutches used to provide the desired capabilities.

Further with respect to the controller 50, this device includes a processor (P) 52 and tangible, non-transitory memory (M) 53 on which is recorded instructions for the present method 100 and/or 200 depending on the design. The controller 50 may be embodied as one or more digital computer devices, and may communicate with the clutches C1, C2 of the transmission 14 and each of the electric traction motors 20, 22 via a controller area network (CAN) bus or other suitable network. The memory 53 may include read-only memory (ROM), flash memory, optical memory, additional magnetic memory, etc., as well as any required random access memory (RAM), electrically-programmable read only memory (EPROM), a high-speed clock, analog-to-digital (A/D) and/or digital-to-analog (D/A) circuitry, and any input/output circuitry or devices, as well as any appropriate signal conditioning and buffer circuitry.

Referring to FIG. 2, the resolver circuit 40 of FIG. 1 is shown in greater detail as it operates with respect to the electric fraction motor 20 of FIG. 1. Operation for the traction motor 22 or any other motor or device having a rotatable shaft 20R would be identical. Central to the resolver circuit 40 is a resolver 42, the output of which is used by the controller 50 in the ongoing control of the traction motor 20. The primary reference winding 41P may be connected to shaft 20R, and carries a positive and negative excitation voltage (EXC+, EXC−, respectively), where EXC=E·sin(ωt), with E being the amplitude of the excitation voltage.

The secondary windings 41S form the sine (SIN) and cosine (COS) windings noted above. The secondary windings 41S carry the positive and negative SIN and COS measurements (SIN+, SIN−, COS+, COS−). That is, electromagnetic coupling induces voltages in the secondary windings 41S of A·sin(ωt)·sin(θ) and A·sin(ωt)·cos(θ), respectively, with A being the attenuated amplitude from the excitation voltage amplitude E. That is, a resolver is a transformer, and thus the voltage at the secondary windings is attenuated by the known transformation ratio of the resolver, as is known in the art. Noise in the induced voltage values may be filtered via a line filter (F), e.g., a band pass filter, of an interface circuit 43 before being relayed to a Resolver-to-Digital Converter (RDC) 44.

The RDC 44 shown in FIG. 2, as is well known in the art, may be embodied as a transducer which converts analog signals from the resolver 42 to digital outputs corresponding to the raw measured shaft angle (θᵣ) and speed (ωᵣ). Physical hardware/software components of a typical RDC may include an oscillator (OSC) 45 such as an electronic circuit that produces a repetitive, oscillating electronic signal, a demodulator chip (DM) 46, and a tracking loop (TL) 48. The demodulator chip 46 is another circuit which applies a demodulation function to analog measurements from the resolver 42 to thereby shift the frequency from amplitude-modulated to baseband. The tracking loop 48 of the RDC 44, also as known in the art, receives the demodulated output from the demodulator chip 46 and tracks the changing angle θᵣ over time, e.g., via a specific transfer function, filters, error calculators/integrators, phase compensators, and the like. The raw position or angle (θᵣ) and raw rotational speed (ωᵣ) are output from the tracking loop 48 to the controller 50. Within the controller 50, enhanced wobble compensation occurs via execution of the method 100 or 200 of FIG. 3 or 4, respectively, such that the controller 50 ultimately outputs control signals (arrow 51) to the fraction motor 20 of FIG. 1.

Referring briefly to FIG. 2A, all raw position measurements may have a periodic position error that can affect the accuracy of the calculation of rotary speed. Examples are shown via traces 55 and 56, where positional and speed wobble (E_{ω}, E_{θ}) are plotted on the vertical axes and raw position θᵣ is plotted on the horizontal axes. Even if actual rotary speed is constant, speed feedback as provided from the RDC 44 of FIG. 2 can have periodic error or “wobble”. As recognized herein, higher motor speeds may produce more pronounced wobble characteristic, as indicated in FIG. 2A by dotted line traces 155 and 156 due to the frequency characteristics of the RDC tracking loop 48 of FIG. 2.

An example of wobble in the raw position θᵣ may be described as follows:

θᵣ=θ₀+A sin kθ₀ (1)

where the subscript 0 denotes the true value, A represents the amplitude of the wobble, and k is the harmonic order (an integer) of the wobble. The raw motor speed (ωᵣ) that is fed back to the controller 50 is the time derivative of motor position (θᵣ). Thus, position wobble affects speed wobble:

$$\begin{matrix}{ω}_{r} = \frac{d {θ}_{r}}{d t} \\ = {ω}_{0} + kA {ω}_{0} cos k {θ}_{0} \\ = {ω}_{0} \cdot ( 1 + kA cos k {θ}_{0} )\end{matrix} \qquad ( 2 )$$

Conventional approaches for compensating for wobble in a motor drive system such as the system 11 of FIG. 1 include measuring rotor position and speed at a relatively low, constant motor speed. Since the actual speed ω₀ is assumed to be constant, any deviation from the average speed is treated as speed error, i.e., E_{ω} of FIG. 2A. Thus, wobble collection methods typically include recording periodic position and speed errors, e.g., in two one-dimensional lookup tables (LUT), adaptive polynomials, or the like, and then using position feedback as the index of the lookup table. Later, the recorded position error is subtracted from the raw position to determine a wobble-compensated position. Similarly, the raw speed from the resolver is divided by the speed gain error to derive a compensated speed. The methods 100 and 200 utilize aspects of this conventional approach in parts as explained below, but also provide additional processing steps which account for wobble at higher motor speeds unlike conventional approaches.

The RDC 44 of FIG. 2 generates the excitation signal (EXC+, EXC−), and the two secondary windings 41S (SIN and COS) are placed orthogonally in the reference frame of the resolver 42 so as to receive the amplitude-modulated signal by the excitation. The absolute resolver position can be obtained by decoding the amplitude of the voltage of the secondary windings 41S. In most cases, the tracking loop 48 is used to decode speed and position from the modulated signals (SIN and COS pairs).

Referring to FIG. 2B, the tracking loop 48 of FIG. 2 has a finite bandwidth (ω_{bw}) which describes the frequency characteristics of the tracking loop 48, as represented via a transfer function G(jω₀) in block 61. Inputs to block 61 include the absolute position and speed as measured by the resolver 42 of FIG. 2, i.e., θ₀ and ω₀. The output of block 61, and thus of the RDC 44 of FIG. 2, is the raw position θᵣ and the raw speed ωᵣ. Equation (1) shown above may therefore be represented as the following equation (3), with ω=kω₀ in block 61 of FIG. 2B:

θᵣ=θ₀+|G(jkω₀)|·A sin(kθ₀−arg(G(jkω₀))) (3)

In FIG. 2B, trace 60 is a plot of the gain amplitude (A), i.e., the value |G(jkω₀)| versus changing motor speed ω, which with k=1 simplifies to |G(jω₀)| as shown. Note that there is no amplitude attenuation in trace 60 when the input signal to the RDC 44 is steady or when the frequency of the input signal to the RDC 44 is much smaller than the bandwidth ω_{bw}. However, this changes as the frequency of the input signal increases, i.e., as motor speed ω increases.

Trace 62 is a plot of the phase, i.e., component arg(G(jkω₀))) of Equation (3) noted above, again with k=1 in this example. There is no phase lag when the input signal is steady. However, the phase of the output signal from the RDC 44 of FIG. 2 lags behind the input signal as speed increases. For this reason, wobble information determined at relatively low motor speeds in the conventional manner is not reflective of wobble occurring at higher motor speeds, as the frequency of the wobble increases proportionally to the motor's operating speed.

As a result, if traces 55 and 56 of FIG. 2A are collected at low motor speeds, the wobble position and speed at the higher motor speeds can be seen as dashed lines 155 and 156, respectively. In such an instance, conventional wobble compensation cannot function properly due to the amplitude and phase mismatch. In other words, it is recognized herein as part of the underlying solution of methods 100 and 200 that in order to properly compensate the wobble at all motor speeds, one must first know the frequency characteristics of the resolver circuit 40 of FIG. 2, and this knowledge must be reflected in the wobble compensation conducted by the controller 50 of FIGS. 1 and 2. Methods 100 and 200 will now be described with reference to FIGS. 3 and 4, respectively.

Referring to FIG. 3, the method 100 for solving the above described wobble compensation problem utilizes the full frequency characteristics of the sensing system. At blocks 102A and 102B, the resolver 42 and RDC 44 of FIG. 2 are used to determine raw resolver position θᵣ and raw resolver speed ωᵣ, respectively. The raw resolver speed ωᵣ is fed into a summation node 111, while the raw resolver position θᵣ is fed into another summation node 110.

At block 104, the raw position θᵣ is used by the controller 50 of FIGS. 1 and 2 to generate an index (IND) in a lookup table. Referring briefly to FIG. 3A, position θ is plotted on the vertical axis of a trace 80, while speed ω is plotted on the vertical axis of another trace 82. Time (t) is plotted on the horizontal axes of traces 80 and 82. The dotted line θ₀ in trace 80 represents the true position as measured by the resolver 42 of FIG. 2. Likewise, dotted line ω₀ in trace 82 represents the true speed, which is constant as shown. Note that the wobble provided by the RDC 44 of FIG. 2 creates an output, e.g., a raw position θᵣ and/or a raw speed ωᵣ, that have a periodic error E_{θ} and E_{ω}, respectively. Both periodic error values are used in method 200, while the periodic error E_{θ} is used in the method 100. Block 104 thus entails generating, over time, the index (IND) of a lookup table (LUT) using this information, with the LUT being a mapping of the errors E_{θ} and E_{ω} with respect to raw position and speed, respectively, as shown by arrows B and C.

Referring again to FIG. 3, at block 106 the controller 50 extracts the position error or wobble (E_{θ}), i.e., the position error, from the lookup table (LUT) for position error noted at block 104, and then feeds this extracted value to blocks 108 and 109. The LUT E_{θ} block 106 of FIGS. 3 and 4 stores the position error, e.g., A sink θᵣ₀ from equation (1), so that the value θᵣ₀ can be determined from the raw position θᵣ.

Block 108 accounts for the dynamics of the RDC 44 of FIG. 2 as the dynamics relate to position θ. As part of block 108, the controller 50 may consider the frequency response of the tracking loop 48 of FIG. 2, as it is detailed in FIG. 2B. That is, each RDC 44 has a corresponding frequency response. Equation (3) above describes the response. Controller 50 can thus subtract the simulated RDC dynamics for position, i.e., G(jkω₀)|·A sin(kθ₀−arg(G(jkω₀))) of Equation (3), from block 108, from the raw position ωᵣ. This step is performed at node 110 of FIG. 3. The output of node 110 is the compensated position (θ_{C}) shown in FIGS. 1 and 2.

At block 109, the method 100 simulates the speed dynamics of the RDC 44. In a simple approach, consider that one could simply calculate the derivative

$$\frac{d }{d t}$$

of the output of block 108 to complete block 109. However, doing so may amplify signal noise at higher frequencies. Therefore, block 109 may include calculating a solution to the following equation (4), which is one example of the transfer function shown graphically in FIG. 2B:

$$\frac{{θ}_{r}}{{θ}_{o}} = \frac{{ω}_{r}}{{ω}_{0}} = G ( s ) = \frac{{ω}_{bW}}{s + {ω}_{bW}} \qquad ( 4 )$$

where s is the Laplace operator and is the same as jω in FIG. 2A. The frequency response for block 109 is thus represented as:

$$\frac{{ω}_{r}}{{θ}_{o}} = {G}_{ω} ( s ) = \frac{s \cdot {ω}_{bW}}{s + {ω}_{bW}} \qquad ( 5 )$$

By embodying block 109 of FIG. 3 as equation (5), a direct implementation of a differentiator is avoided, along with its noise, and the entire transfer function G_{ω}(s) acts as a high-pass filter, as will be appreciated by one of ordinary skill in the art.

The output of block 109 of FIG. 3, i.e., the compensated speed wobble E_{ωC}, is then passed to node 111 where it is subtracted from the raw speed ωᵣ from block 102B. The output of node 111 is the compensated speed ω_{C} shown in FIGS. 1 and 2.

The method 100 of FIG. 3 thus includes simulating the frequency response of the resolver circuit 40 of FIG. 2 as a function of an input position. The method 100 gives an ideal compensation, and can provide optimal wobble compensation performance provided the frequency model, an example of which is shown in FIG. 2B, can provide sufficient resolution of the frequency signal, which is limited to the sampling of the digital signal within the RDC 44. Also, relative to conventional approaches, the method 100 uses just one lookup table, i.e., for the position error E_{θ}. This may save memory usage of the controller 50, but may require additional processing time. Typically, position and speed are sampled at the current control rate of the controller 50, usually about 10 kHz-20 kHz, and thus digital implementation of a complex frequency model may require execution time. Thus, the option of method 200 exists as a compromise.

Referring to FIG. 4, in alternative method 200, blocks 102A, 102B, and 104 of FIG. 3 progress as explained above. However, block 103 applies a low-pass filter (LPF) to the raw speed ωᵣ and passes the filtered value to blocks 105 and the raw speed ωᵣ to node 113. Block 103 is needed to reduce the noise typically seen in the raw speed ωᵣ output from the RDC 44 of FIG. 2. The particular noise characteristics can be determined for a given RDC 44, and the bandwidth of the filter applied at block 103 can be tuned beforehand to eliminate the majority of the noise.

Block 105 is then inserted to cause a shift of the index (IND) for the raw position lookup table previously indexed at block 104 as a function of the filtered motor speed, i.e., the value output from the low-pass filter of block 103. Block 105 specifically simulates the phase shift shown in FIG. 2B as incurred by the frequency response of the resolver circuit 40 of FIG. 2. The index shift of block 105 may be captured as an equation or in a lookup table, as will be appreciated by one of ordinary skill in the art.

Thus, block 106 of FIG. 4 proceeds exactly as explained above, but with the shifted index (IND) as the input. Block 107 does the same thing, but for a different lookup table for speed error (E_{ω}), i.e., a speed gain error. That is, block 107 stores the speed gain error, e.g., (1+kA cos kθᵣ₁₀), which is the gain of equation (2), so that ωᵣ₀ can be determined from the raw speed ωᵣ. The output of block 106 is subtracted at node 110 from the raw speed from block 102A. The raw speed co, from block 102B is then divided at node 113 by the gain from block 107 to provide the compensated speed ω_{C}. Since block 105 does not compensate for the amplitude attenuation depicted in FIG. 2B by trace 60, the performance of method 200 may not be as optimal as that of method 100. However, method 200 has the merit of quicker execution time over method 100, and simplicity of encoding block 105.

Upon execution of method 100 or 200, the controller 50 of FIG. 1 can use the compensated speed and position, i.e., ω_{C} and θ_{C}, respectively, to control operation of the motor 20 or 22 of FIG. 1. Control actions can include transmitting the control signals 51 to the motor 20 or 22 as a current control command to cause an increase or decrease in speed, to turn the motor 20, 22 on or off, or any other control action as needed.

While the best modes for carrying out the invention have been described in detail, those familiar with the art to which this invention relates will recognize various alternative designs and embodiments for practicing the invention within the scope of the appended claims.

1. A vehicle comprising:
an electric motor having a rotor shaft;
a transmission having a gear set which is connected to the motor;
a resolver circuit having a resolver which measures an absolute position of the rotor shaft, and a resolver-to-digital converter (RDC) which receives the measured absolute position as an input signal and generates, via a tracking loop, a raw position signal as an output signal; and
a controller in communication with the electric motor and with the RDC, wherein the controller includes a processor and tangible, non-transitory memory on which is recorded predetermined frequency characteristics of the RDC and instructions, executable by the processor, to cause the controller to:
receive the output signal from the RDC;
extract position wobble information from a lookup table using the received output signal from the RDC;
apply the predetermined frequency characteristics to the extracted position wobble information thereby derive a compensated position signal; and
control an operation of the electric motor using the compensated position signal.

2. The vehicle of claim 1, wherein the predetermined frequency characteristics are a transfer function describing position dynamics of the RDC, and wherein the controller applies the predetermined frequency characteristics by subtracting the position dynamics from the raw position signal to thereby derive the compensated position signal.

3. The vehicle of claim 2, wherein the RDC generates, via the tracking loop, a raw speed signal as another output signal, and wherein the controller is configured to derive speed dynamics from the position dynamics and to calculate the compensated speed signal by subtracting the derived speed dynamics from the raw speed signal.

4. The vehicle of claim 1, wherein the transmission includes a clutch, and wherein the electric motor is a traction motor which is selectively connected to a node of the gear set via engagement of the clutch.

5. The vehicle of claim 1, wherein the electric motor is a traction motor which is continuously connected to a node of the gear set via an interconnecting member.

6. The vehicle of claim 1, wherein the operation of the electric motor is a current command to the electric motor.

7. A method comprising:
measuring an absolute position of a rotor shaft of an electric motor via a resolver;
receiving the absolute position as an input signal via a resolver-to-digital converter (RDC) having a tracking loop;
generating from the absolute position, via the tracking loop of the RDC, a raw position signal as an output signal;
transmitting the output signal to a controller; and
via the controller:
extracting, from a lookup table, position wobble information corresponding to the raw position signal;
automatically compensating the extracted position wobble information at all rotational speeds of the rotor shaft by applying predetermined frequency characteristics of the RDC to the extracted position wobble information to thereby derive a compensated position signal; and
controlling an operation of the electric motor using the compensated position signal.

8. The method of claim 7, wherein the predetermined frequency characteristics are embodied as a transfer function describing position dynamics of the RDC, and wherein automatically compensating for the position wobble in the lookup table includes subtracting the position dynamics from the raw position signal to thereby derive the compensated position signal.

9. The method of claim 7, further comprising:
generating, via the tracking loop, a raw speed signal as another output signal;
deriving speed dynamics from the position dynamics via the controller; and
calculating the compensated speed signal by subtracting the derived speed dynamics from the raw speed signal.

10. A method comprising:
measuring an absolute position of a rotor shaft of an electric motor via a resolver;
receiving the absolute position as an input signal via a resolver-to-digital converter (RDC);
generating from the absolute position, via the RDC, a raw position signal as an output signal;
transmitting the output signal of the RDC to a controller having a lookup table containing position wobble information; and
via the controller:
shifting an index of the look up table as a function of the raw position;
extracting the position wobble information from the lookup table after shifting the index to thereby derive a compensated position signal; and
controlling an operation of the electric motor using the compensated position signal.

11. The method of claim 10, further comprising:
deriving a raw speed signal from the raw position signal;
applying a low-pass filter to the raw speed signal to generate a filtered raw position speed signal; and
automatically shifting the index as a function of the filtered raw position speed signal to thereby simulate a phase shift of the predetermined frequency response.

12. The method of claim 10, further comprising generating a lookup table of speed wobble gain information using the shifted index, and calculating a compensated speed signal by dividing the raw speed signal by the speed wobble gain information.
